(19) United States
(12) Patent Application Publication
(10) Pub. No.: US 2010/0130186 A1
(43) Pub. Date: May 27, 2010

(54) SYSTEM AND METHOD FOR DIRECTORY ASSISTANCE INCLUDING SMS SUPPORTED PRIVACY FEATURES

(76) Inventors: Faith L. McGary, Katy, TX (US); Alexis Tabora Adorable, Bislig (PH); Christian Paolo Barredo Pestelos, Caloocan City (PH); Julianito Ofiate Abanilla, JR., Sariaya (PH)

Correspondence Address: SOFER & HAROUN LLP., 317 MADISON AVENUE, SUITE 910, NEW YORK, NY, 10017, US

(21) Appl. No.: 12/579,074

(22) Filed: Oct. 14, 2009

Related U.S. Application Data
(60) Provisional application No. 61/196,108, filed on Oct. 14, 2008.

(51) Int. Cl. H04M 3/42; H04W 4/12

(52) U.S. Cl. 455/417; 379/211.01

(57) ABSTRACT

A method for providing communications between a requester and a desired party including receiving a request from a requester for information related to a desired party and retrieving at least one connection information related to the desired party. At least one connection message is sent to the desired party including at least one identifying information about the requester nd further offering the desired party at least one option for reply to be selected among of plurality of available predefined options. A reply is received from the desired party indicating an instruction for handling the request from the requester.

### RELATED APPLICATION

This application claims the benefit of priority from U.S. Provisional Patent Application No. 61196108, filed on Oct. 14, 2008, the entirety of which is incorporated by reference.

### BACKGROUND

1. Field of the Invention

This application relates to a system and method for communication services. More particularly, the application relates to a system and method for communication services offering connection to desired parties.

2. Description of Related Art

In the area of directory assistance, a requestor is typically seeking connection information or connection to a desired party. Additionally, numerous examples exist where connectivity content for mobile contact information via directory assistance can only be accessed in a secure manner from a variety of methods. However, the various existing solutions for providing wireless/mobile contact information may not achieve the combined advantageous features of contact information security (both to the contacts themselves as well as the overall security of the databases), feasibility for integration into existing systems, and usability from a customer perspective.

### OBJECTS AND SUMMARY

The present arrangement solves the problems of the prior art by providing a method of connecting with a mobile/wireless device of a desired party that maintains the security of the desired party's contact information.

To this end a method is provided for communications between a requester and a desired party including receiving a request from a requester for information related to a desired party and retrieving at least one connection information related to the desired party. At least one connection message is sent to the desired party, including at least one identifying information about the requester and offering the desired party at least one option for reply to be selected among of plurality of available predefined options. A reply is received from the desired party indicating an instruction for handling the request from the requester.

### BRIEF DESCRIPTION OF THE DRAWINGS

The present invention can be best understood through the following description and accompanying drawings, wherein:

FIG. 1 illustrates a system for communication in accordance with one embodiment;

FIG. 2 is a flow chart showing the operations of the communication system of FIG. 1, in accordance with one embodiment;

FIG. 3 is a system flow diagram showing one exemplary call flow through the system of FIG. 1, in accordance with one embodiment;

FIG. 4 is a system flow diagram showing one exemplary call flow through the system of FIG. 1, in accordance with one embodiment; and

FIG. 5 is a system flow diagram showing one exemplary call flow through the system of FIG. 1, in accordance with one embodiment.

### DESCRIPTION

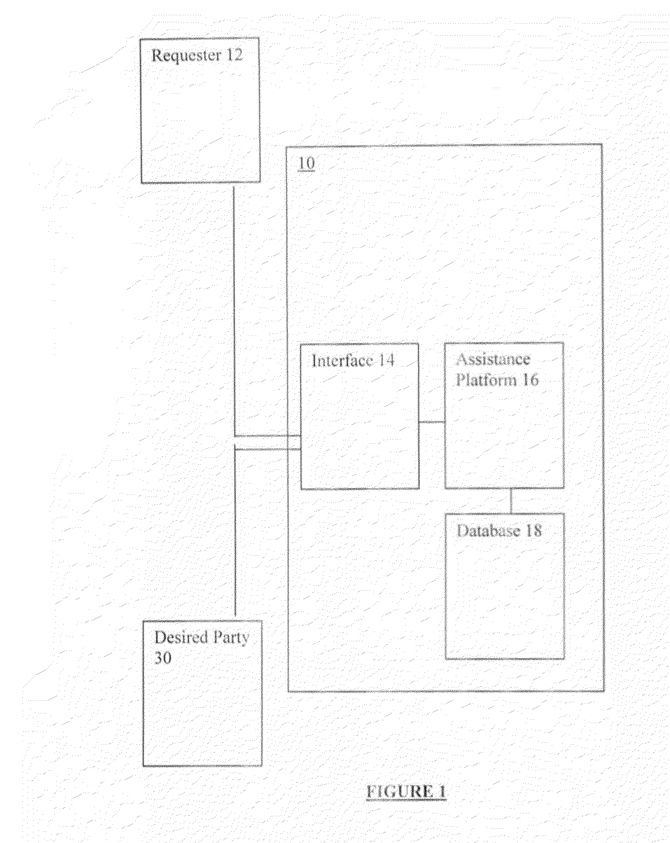

In one arrangement as shown in FIG. 1 a connection platform 10 is shown. Platform 10 is configured to receive communications from a requester 12 at a communication interface 14. Once received, the communication is transferred to an assistance platform 16 within system 10 and coupled to a listing database 18. Such a system is arranged such that requester 12 may seek a contact information and connection to one or more desired parties 30.

Requester 12 may be an individual seeking a desired party 30 using any device, including but not limited to a land line telephone, desk top computer, mobile electronic device with communication capabilities (mobile phone, PDA, mobile e-mail device, web enabled mobile device etc.). Requester 12 is capable of communicating a request for a contact information for a desired party, such as party 30, so as to initiate some form of communication with them.

For the purposes of illustrating the salient features, requester 12 is designated as a mobile telephone user with text SMS capabilities, however, the invention is not limited in this respect.

Interface 14 of platform 10, as well as the carrier of requester 12 are configured to support any form of electronic or telephonic incoming and outgoing communication formats, including but not limited to telephone, SS7 signalling, cellular telephone, SMS, e-mail, Live chat, MMS, HTML, or any other of such formats.

Once received, interface 14 transfers the request communication to assistance platform 16 for handling of the request, with any format translations if required. Assistance platform 16 may be either live operator(s), IVRs (interactive Voice Response) units or some combination of the two.

Database 18 is configured to store listing (contact) information for any number of desired parties 30. This information may be provided to system 10 by the parties' carriers or directly by parties 30. The information is formatted for retrieval by assistance platform 16. It is contemplated that databases 18 may be maintained internally by system, may be purchased from and/or located at third party venders, or may be a combination of the two.

In the context of this basic configuration, one embodiment of the present arrangement provides an improved method for allowing requester 12 to contact platform 10 and request a mobile contact number of desired party 30. According to the arrangement, assistance platform 16 searches for a desired contact of a party 30, and, if found, sends a message to them to ascertain some form of permission to allow a form of connection between the original requester 12 and themselves. The following descriptions include several exemplary embodiments of such a directory assistance arrangement.

It is noted that the following descriptions take into account that:
1) Mobile Originated/Mobile Terminated (MO/MT) SMS(s) may traverse a given network;
2) The system's 10 termination and origination of SMS(s) can be completed via an aggregator or via a proprietary system or service;
3) Party A (requester 12) and Party B (contact being sought 30) can be on the same network (carrier) or diverse;
4) Carrier Networks generally describes the path that a message will traverse. This can be a data or telephony system;
5) The handset that either party uses can receive and send SMS information;
6) If the handset cannot, then another system or apparatus may perform the SMS function along with the display of the information;
7) Access to the content is assumed to be through an appropriate data interface or network;
8) The protocol used for these transmissions is arbitrary;
9) There is a unique ANI/MIN/DN/TN for each Party (A and/or B);
10) System 10 may or may not verify Party A's (12) information sent to Party B (30);
11) System 10 may identify objectionable content and restrict its transmission;
12) System 10 may warn the desired party 30 to save the message and log for future violations;
13) the terms “platform” and “system” are used interchangeably to describe a arrangement of servers and equipment required to process information, a call or request. Platform/system 10 refers to the communication system as a whole and platform/system 16 refers to at least one sub-component of system 10 that handles the request from requester 12 to connect to desired party 30.

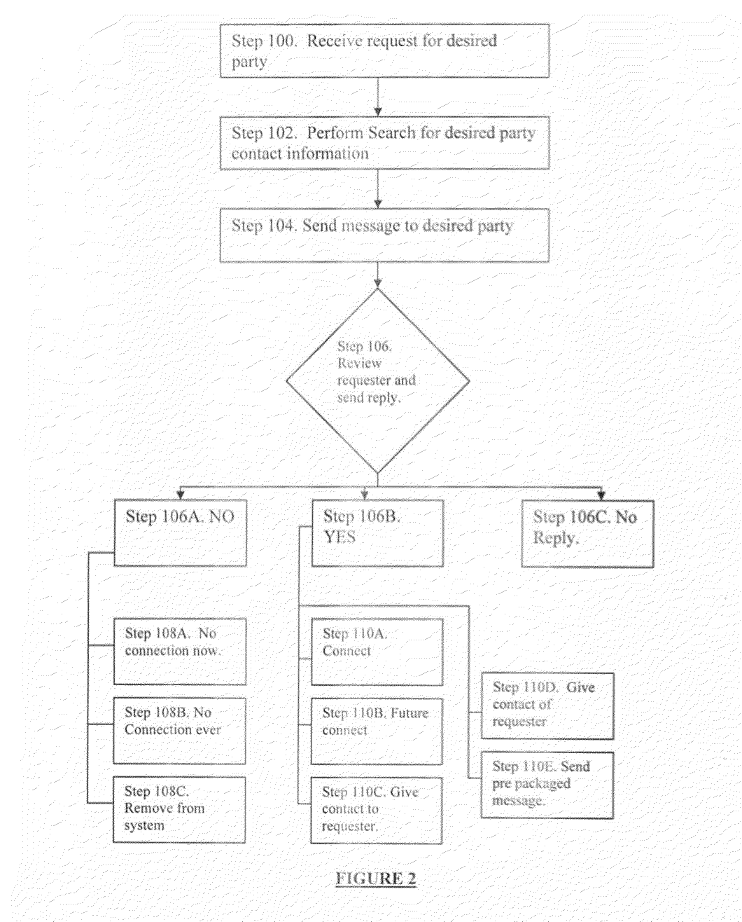

Turning to the operation of the exemplary embodiments described herein, in one exemplary embodiment as described in connection with FIG. 2, at step 100, a request from Party A (12) is received by system 10 for a contact information for desired Party B (30). At step 102, Party B is searched for by platform 16 within database 18. At step 104, if located, system 10 sends message to Party B identifying Party A, for example, by name or telephone number of a combination of the two. At step 106, Party B replies to the system using either telephonic key codes or text communication in any one of three options:
1. Party B responds with “no” (106A)
2. Party B responds with “yes” (106B)
3. Party B does not respond (106C)

In the instance of the first option 106A, at step 108 Party B may chose to:
1. Do not accept a call at this time (108A)
2. Never accept a call from Party A (108B)
3. Never accept a request from/with this service (opt-out) (108C)

At selection of 108A, platform 16 of system 10 notifies requester 12 (Party A) that Party B does not accept the attempted retrieval of their wireless contact information. At the selection of 108B platform 16 of system 10 further records in database 18, for that desired party 30 (Party B), that they never want to accept retrieval of their wireless contact information for that requester 12. In such an instance system 10 may add Party A to a permanently blocked list for Party B, (or request of Party B the same) if some combination of non-responses and ‘no’ responses occur from the same Party B (30) relating to Party A (12).

At the selection of 108C platform 16 of system 10 records in database 18, that desired party 30 (Party B) has opted out of all future attempts to reach their contact information for all requesters 12.

Alternatively, if Party B (30) accepts the request at step 106B, then Party B may chose at step 110 to Connect to requester 12 immediately (step 110A) which may include telephonic or two way text communications initiated or facilitated by system 10.

Alternatively, at step 110B, Party B (30) may request connection to Party A at a specific time XX:XX in the future.

Alternatively, at step 110C, Party B (30) may request that system 10 provide Party A with Party B's contact information.

Alternatively, at step 110D, Party B (30) may request that system 10 provide them with the contact information of Party A (12), so that they may seek connection at some later time. This information may be provided verbally or in text format.

Alternatively, at step 110E, Party B (30) may send, or have system 10 send, a prepackaged message to Party A (12). For example “In the middle of a discussion not a good time.” This option may additionally include some of the above options regarding the transmission of contact data.

In the alternative, should Party B simply not respond (step 106C), then system 10 will notify requester 12 of that non-response, after some predefined time frame. Potentially, after several “no responses” to requests from a particular Party A, system 10 may proceed as described above in step 108B. Potentially, after several “no responses” to requests from all Parties A (12), system 10 may proceed as described above in step 108C.

In another embodiment, system 10 may log any and all abuse that can be identified. For example, an algorithm may be deployed to develop a score for Party A, when such a Party A should be recommended for censure. This may be generally executed for vulgar content or messages of a threatening nature.

The following is one exemplary connection pattern, through system 10, where Party B (30) declines a request to be connected with Party A (12) as described above in step 106A.

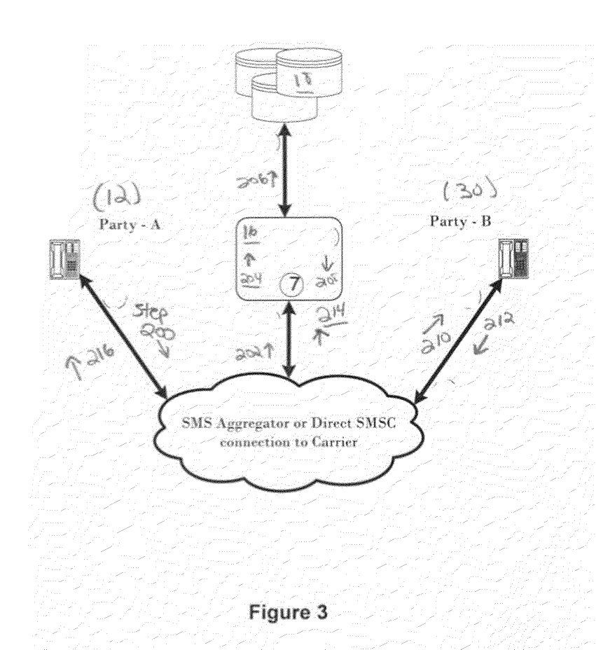

As shown in flow/system diagram FIG. 3, at a first step 200, Party-A sends an SMS message to a pre-defined number or short code, some attributes that describe Party-B. At step 202, the message (information) is passed through the network interface 14 to platform 16. The message is parsed, reformatted and assigned a unique identifier for tracking through system 10

At step 204, the unique identifier may also be used to link Party-B's response to Party-A's initial request. Next, at step 206, platform 16 queries database 18 to uniquely identify information for Party-B. Once a response is returned to platform 16, at step 208 system 10 reformats the information in the form of a request to Party-B.

The formatted request is sent from system 10, via Party B's carrier network, to Party-B's device at step 210. Party-B's response to Party-A's request falls into one of the above described options set forth in step 106A-106C. (For this call flow it is assumed Party-B sends, or selects, a “No” response (106A)). Party-B's response traverses their carrier network back to platform 16 at step 212. At step 214 Party-B's return response is matched with the Party-A's initial request and stored, for example in database 18. The message or request matching is accomplished via the unique identifier and/or attributes of Party-A and/or Party-B.

At step 216, platform 16 sends a message back to Party-A, via a network, that Party-B does not wish to communicate. The message created may initially be a pre-formatted message. However, a dynamically created message may be sent based on actions of Party-A and responses from Party-B.

The following is one exemplary connection pattern, through system 10, where Party B (30) accepts a request to be connected with Party A (12) as described above in step 106B. In this first exemplary scenario Party-B receives Party-A's information (step 110C), a phone number in this example, Party B (30) calls them directly via a telephony network. The information communicated could be an email address, SMS/MMS/WAP information or Instant Message Address.

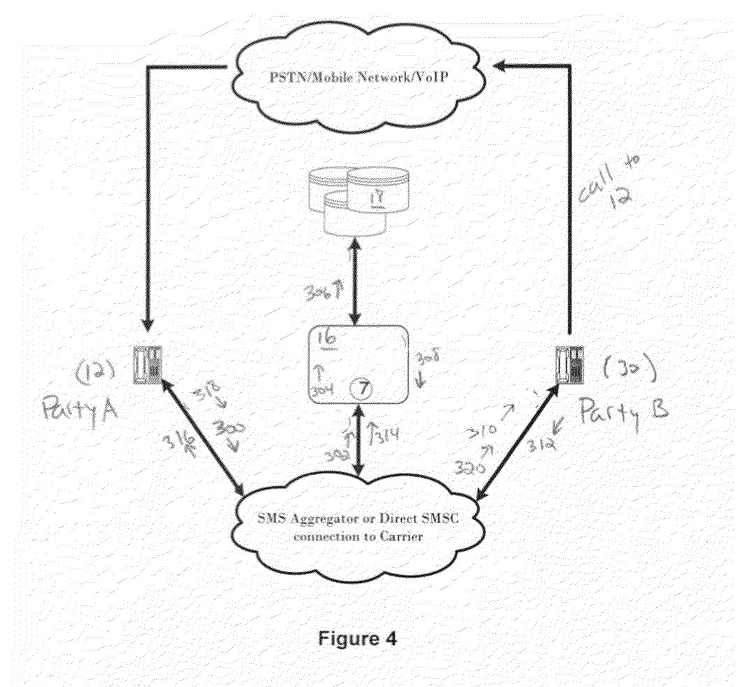

At step 300, as shown in system flow diagram FIG. 4, Party-A SMS(s) to a predefined number or short code, some attributes that describe Party-B (30), and, at step 302, the message (information) is passed through system 10 to platform 16. The message is parsed, reformatted and assigned a unique identifier for tracking through system 10.

At step 304, the unique identifier is used to link Party-B's response to Party-A's initial request. Next, at step 306, system 10 queries database 18 to uniquely identify information for Party-B. Once a response is returned to platform 16, at step 308, system 10 reformats the information in the form of a request to Party-B (30). Initially, the request is to accept Party-A's invitation to talk. However, the request may be for other services.

At step 310, the formatted request is sent from system 10 to Party-B's device. Next, at step 312, Party-B's response to the Party-A's request falls into one of the options selected above (steps 106A-106C). For this scenario Party-B sends, or selects, a “YES” response (106B). At step 314, Party-B's response traverses a network back to platform 16 and is matched and stored against Party-A's initial request. This matching may be advantageously accomplished via the universal identifier and/or attributes of Party-A and/or Party-B.

At step 316, platform 16 sends a message to Party-A notifying them that Party-B has accepted their request to communicate. At step 318, Party-A initiates the service to communicate, for example by a button press or code delivery. In this context, “service” may mean telephone call, email, direct SMS/MMS or Instant Message. As such, at step 320, platform 16 sends a message to Party-B with Party-A's contact details.

Thus, by the above scenario, Party-B has elected to place a call to Party-A via a voice network. Such communication is based upon the information that is sent back to Party-B. There are no timeframes or time outs for this initiation to begin and if Party-B elects not to call, then the system or Party-A are not informed. Once the call from Party-B passes through their carrier network to Party-A, Party-A can elect or reject to pick up the call and communicate with Party B if they have changed their mind. Regarding security, at this point, based on Party-B's telephony provider's network, the services they have elected with that provider and Party-B services (ANI restriction/blocking) may determine whether caller-ID is offered for the call received from Party-B.

The following is another exemplary connection pattern, through system 10, where Party B (30) manages the connection of the two Parties via its system 10 or a third-party carrier network. In this example, neither Party, A or B, receives identifying information of the other (step 110). The only vehicle for communication is through system 10, or an agent of the system's network.

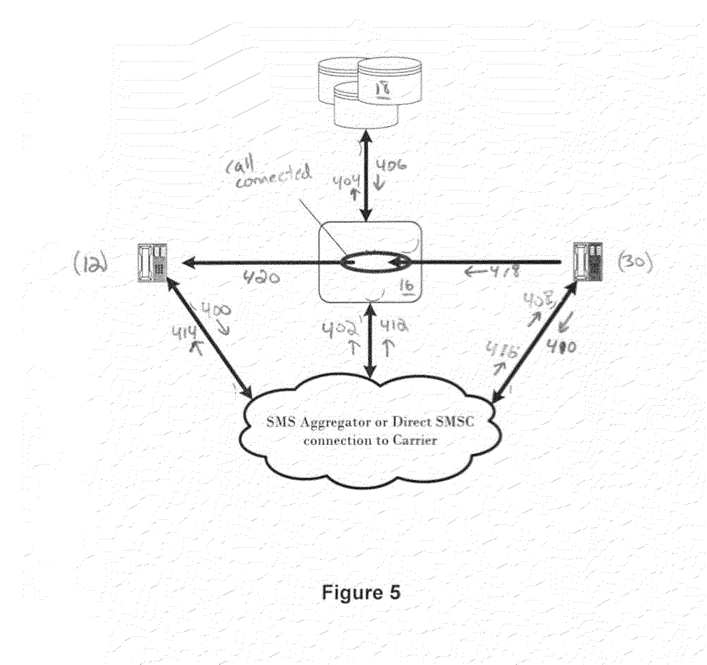

At step 400, as shown in system flow diagram FIG. 5, Party-A SMS(s) to a predefined number or short code, some attributes that describe Party-B. At step 402, the message (information) is passed through system 10 to platform 16. The message is parsed, reformatted and assigned a unique identifier for tracking through system 10. The unique identifier may also be used to link Party-B's response to Party-A's initial request.

At step 404, system 10 queries database 18 or sources to uniquely identify information about Party-B. Once a response is returned to platform 16, at step 406, system 10 reformats the information in the form of a request to Party-B. At step 408, the formatted request is sent from system 10, to Party-B's (30) device.

Next at step 410, Party-B's response to Party-A's request falls into one of the options discussed above (106A-106C) For this call flow Party-B sends, or selects, a “YES” response as set forth in step 106B. At step 412, Party-B's response traverse their carrier network and system 10 back to platform 16, where it is matched with Party-A's initial request and stored. The message or request matching may be accomplished via the unique identifier and/or attributes of Party-A and/or Party-B.

At step 414, platform 16 sends a message to Party-A notifying them that Party-B has accepted their request to communicate. At step 416, platform 16 sends a message to Party-B with a toll-free number for North America or a free-phone number for Europe, to communicate with Party-A. In one arrangement, system 10 may have a pool of toll free (free number) numbers to assign based upon expected call volume(s).

In this call flow, Party-B, at step 418 places a call to the toll-free number via the voice network. For example, system 10 may store with a unique identifier the name/contact of Party B as well as the requesting party A and their contact information as well. The toll free number(s) terminate on the network of system 10. Party B's communication to system 10, when received is analyzed using identification information such as Party B's ANI (Automatic Number Identifier) to retrieve the necessary contact information of requesting Party A (12). There are no timeframes for this initiation to begin.

In one arrangement, platform 16 is configured, based on a set of criteria and timeframe, to send SMS(s) reminders to Party-B to call, based on prior acceptance (at step 106A). Platform 16 may also be configured, based on a set of criteria and timeframe, to send SMS(s) to Party-A notifying them that Party-B has not yet initiated a call to them.

At step 420, once a call has been received at system 10 from Party-B, system 10 initiates a call to Party-A. If Party-A picks up the call from system 10, then Party-A and Party-B are conferenced together, via platform 16. System 10 may elect to play an announcement once the conference begins, such as “Your connection was made possible by the services of (XXX).” Additionally, once Party A and B are conferenced, other add-on services can be made available to one or both parties. For example, a key-press (* or #) may be configured to conference in an operator of platform 16 to ask a question or receive additional information.

In one arrangement a subscriber profile registry may hold (remember) information about requester 12 so they do not have to be prompted again. As an example, the language preference of requester 12, once chosen by a requester/caller 12, such as Spanish, may be stored so that all subsequent transactions with system 10 and requester 12 are automatically conducted in Spanish without further prompting.

In another embodiment, look ahead call systems that allow the system to proactively determine the state of the called Party B (30) prior to even attempting connection. In the SMS context, the look ahead feature may inform system 10 if Party B (30) was available to receive a call. If so, then the call would progress. If not, then a message could be played to the requester 12 that second Party B (30) is not available (for technical reasons) at this time.

In another embodiment, system 10 may attempt to verify Party A (12) prior to sending a request to Party B (30). Based on public records, predefined or dynamic security questions Party-A (12), may be “validated” to continue through the system to communicate with Party-B. This could be used to catch unauthorized telemarketer requesters 12.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method for providing communications between a requester and a desired party, said methods comprising the steps of:
receiving a request from a requester for information related to a desired party;
retrieving at least one connection information related to said desired party;
sending at least one connection message to said desired party, said connection message including at least one identifying information about said requester, said connection message further offering said desired party at least one option for reply to be selected among of plurality of available predefined options;
receiving a reply from said desired party, said reply indicating an instruction for handling said request from said requester.

2. The method as claimed in claim 1, wherein said information related to said desired party is a connection information.

3. The method as claimed in claim 2, wherein said connection information is selected from the group consisting of telephone numbers, SMS addressing, e-mail, and live chat designations.

4. The method as claimed in claim 1, wherein said connection message sent to said desired party identifies said requester, to said desired party by any one of requester's telephone number, requester's name or a combination of the both requester's name and telephone number.

5. The method as claimed in claim 1, wherein said step of offering said desired party at least one option for reply includes offer for connecting to said desired party, denying connection to said desired party and opting out of said method for all possible requesters.

6. The method as claimed in claim 5, wherein after said step of receiving a reply from said desired party indicating an instruction for handling said request from said requester, if said desired party accepts said request, said method further includes the step of connecting said desired party to said requester 12.

7. The method as claimed in claim 6, wherein said connection of said desired party and said requester is done in either one of a telephonic connection or a two way text communication.

8. The method as claimed in claim 5, wherein after said step of receiving a reply from said desired party indicating an instruction for handling said request from said requester, if said desired party accepts said request, said method further includes the step of providing said desired party connection to said requester at a specific time in the future.

9. The method as claimed in claim 5, wherein after said step of receiving a reply from said desired party indicating an instruction for handling said request from said requester, if said desired party accepts said request, said method further includes the step of delivering connection information of said desired party to said requester.

10. The method as claimed in claim 5, wherein after said step of receiving a reply from said desired party indicating an instruction for handling said request from said requester, if said desired party accepts said request, said method further includes the step of delivering a connection information of said requester to said desired party.

11. The method as claimed in claim 5, wherein after said step of receiving a reply from said desired party indicating an instruction for handling said request from said requester, if said desired party accepts said request, said method further includes the step of sending a prepackaged message to said requester.

12. The method as claimed in claim 5, wherein after said step of receiving a reply from said desired party indicating an instruction for handling said request from said requester, if said desired party accepts said request, said method further includes the step of delivering a system contact number to said desired party, allowing them to contact a directory system for connection to said requesting party, without disclosing their contact information to said requester.

13. The method as claimed in claim 12, further comprising the step of sending a reminder to said desired party to utilize said system contact number to connect through said system with said requester.
